(19) United States
(12) Patent Application Publication
(10) Pub. No.: US 2010/0271675 A1
(43) Pub. Date: Oct. 28, 2010

(54) METHOD FOR ENCODING A COMPUTER-GENERATED HOLOGRAM

(75) Inventors: Norbert Leister, Dresden (DE); Ralf Haussler, Dresden (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SeeReal Technologies S.A., Luxembourg (LU)

(21) Appl. No.: 12/161,281

(22) PCT Filed: Jan. 15, 2007
(86) PCT No.: PCT/EP2007/000298

§ 371 Date: Jun. 16, 2010

(30) Foreign Application Priority Data
Jan. 18, 2006 (DE) 10 2006 003 741.3

(51) Int. Cl. G03H 1/08

(52) U.S. Cl. 359/9

(57) ABSTRACT

The object of the invention is to improve the quality of encoding a CGH of a three-dimensional object on a light modulator with the help of an iterative method with phase encoding and thus to improve the reconstruction quality. Based on given object data sets, a two-dimensional distribution of N complex values of a wave field in a virtual observer window (2), which is located within a transformation area (1), is calculated. The distribution forms there a distribution of complex set-point values, which serves as a basis for comparison for an iterative calculation of the code. Following process steps are carried out: the distribution is transformed into the plane of the light modulator (5) where it is represented with the help of phase encoding, wherein k phase values represent each complex value of the transformation as initial values for iterative calculation, the iterative calculation between two planes, namely the observer plane (7) and the plane of the light modulator (5), is repeated in iteration steps until a defined interruption criterion is reached. The method can be applied in holographic display devices.

The present invention relates to a method for encoding a computer-generated hologram (CGH) of a three-dimensional object on a spatial light modulator (SLM), where the reconstruction of this object is visible through an observer window which is located in an observer plane. The CGH is represented by way of phase encoding, thereby using a transformation algorithm for iterative calculation of the control values of the CGH. The reconstruction of the three-dimensional object is generated through diffraction of sufficiently coherent light at controllable pixels of the light modulator, such as a phase-modulating SLM. The invention further relates to a holographic display device, which contains the means for executing the encoding method.

In this document, the term ‘SLM’ denotes an electronic medium used for controlling intensity (amplitude), colour and/or phase of a wave field by way of modulating light beams emitted by one or several independent light sources. The SLM contains a multitude of electronically controllable pixels which are arranged in a regular pattern and which encode the CGH. In this document, k adjacent pixels are combined to form one element for phase encoding with k phase components. Here, two-phase encoding will be described as an example for phase encoding with k components. However, the description of the present invention applies likewise to phase encoding with a larger number of components. In this document, the term ‘transform’ shall include any transform which is suitable to effect the propagation of light waves. This includes, for example, Fresnel transforms and Fourier transforms.

The reconstruction of a three-dimensional object in a holographic display device is adversely affected by reconstruction errors, e.g. caused by disturbing light of other diffraction orders or by the CGH encoding method in accordance with the display components used, e.g. an amplitude- or phase-modulating SLM. Correction or elimination of such influences improves the quality of the reconstruction in the holographic display device.

A method for calculating a CGH and a corresponding device for encoding the same on an amplitude-modulating SLM are described in the patent application no. DE 10 2004 063 838 filed by the applicant, which has not yet been published. A CGH is calculated and encoded on an amplitude-modulating SLM using a suitable method. It is possible to achieve a good CGH reconstruction quality using that configuration. In contrast to classic holograms, encoded CGHs are the result of the calculation of hologram data sets from object data sets of two-dimensional object layers, i.e. parallel sections of a three-dimensional object, and of their storage using for example electronic means in an electronic storage medium of a computer. Object data sets contain complex phase and amplitude values of a multitude of object points in the individual object layers and thus the entire object information of the three-dimensional object. The complex hologram data, which are computed based on the object data sets, are used to encode an SLM, which electronically influences the amplitude and/or phase of light which is capable of generating interference. The three-dimensional object can thus be fully reconstructed from these data and is visible as a holographic representation from the appropriate perspective in an observer window located near the eyes of an observer. The three-dimensional object can either be a fix object or a sequence of movable images of a real or virtual scene. As far as the present invention is tangent to that patent application, it will be explained in more detail below in the description of embodiments.

Another way of encoding CGHs is to employ the method of phase encoding in conjunction with a phase-modulating SLM, where the two-phase encoding method is preferred. Here only the phase of the light is directly modulated in the place of the SLM. The principle of two-phase encoding is based on the idea that a complex value can be represented by two phase values with constant amplitude. Each complex value with the phase ψ and the amplitude a ranging between 0 and 1 is thus represented by the sum of two complex numbers with the absolute value 1 and the phase values ψ±a cos a. However, there are also other possibilities of representing a set of complex values by two or more phase values per complex value. The terms ‘two-phase encoding’ and ‘phase encoding with k components’ are to be construed in a general sense here.

The two-phase encoding method is used in conjunction with a phase-encoding SLM in order to represent the phase values. If it was possible to encode the two phase values at one and the same position on the SLM, a thus encoded CGH made it achievable to reconstruct the three-dimensional object free of errors. In practice, however, the phase values can only be written to two adjoining controllable pixels in a row (or column) of the SLM, so that they are offset locally. If encoding was done using more than two phase values, the conditions would behave in analogy with the number of phase values. That offset causes errors in the reconstruction of the CGH.

However, phase encoding boasts several advantages over encoding an amplitude hologram on an amplitude-modulating SLM. Using two-phase encoding, it is possible to achieve greater brightness of the reconstruction, because the pixels of the phase-encoding SLM have maximum transmittance. Because of the fact that the object is reconstructed in the zeroth diffraction order of the light used, it is another advantage of the two-phase encoding method that it shows a more favourable wavelength dependency, which facilitates the representation of colour holograms. However, this encoding method has the disadvantage that the holographic reconstruction quality is much poorer, e.g. compared with the Burckhardt encoding method for an amplitude-modulating SLM.

Consequently, measures to improve the reconstruction quality must be taken to be able to take advantage of the positive aspects of the two-phase encoding method. The reconstruction quality can for example be improved by employing an iteration algorithm when encoding the CGH. Several general iteration methods are known from the literature.

The most common one is the iterative Fourier transform algorithm developed by GERCHBERG and SAXTON, which is described in detail in a number of publications. It is used as the general basis for many iteration methods. This algorithm transforms and back-transforms iteratively between a given function and its Fourier transform. The deviations from the set-point values in the two functions are minimised gradually by using the degrees of freedom. The transformations are carried out for example between the plane of a light modulator and the reconstruction plane of a two-dimensional object. The intensity distribution in the object plane is often meant to have a certain value while the phases of the complex values can be chosen freely and are adjusted to minimise errors. However, it is in most cases not possible to fully eliminate the reconstruction errors.

Another method of representing a CGH as a phase hologram is called kinoform. In his document “Spectrum leveling by an iterative algorithm with a dummy area for synthesizing the kinoform” HIROSHI AKAHORI describes an iteration method used to compute a kinoform. If a phase-modulating SLM is used, a kinoform element only consists of one controllable pixel which can be only filled with the phase value of a complex value. The absolute value of the complex number is set to 1 irrespective of its actual value. Because of this encoding procedure, the reconstruction of the object will be erroneous. In order to correct this error, an iteration is performed based on a window which is computationally introduced in the object plane. This window contains a signal area and a so-called dummy area. In the signal area the intensity signals of the original object shall be restored for that area using an iteration method. In the individual iteration steps the absolute values of the set-point values are replaced and the phase values taken from the previous computation. This procedure can only be applied to one- and two-dimensional objects.

Iteration methods are most frequently used in applications where the light intensity in a single plane is to be optimised. This would correspond with the reconstruction of a two-dimensional object. An extension of the range of applications of these methods to a number of reconstruction planes is described in the document “Interactive application in holographic optical tweezers of a multi-plane GERCHBERG-SAXTON algorithm for three-dimensional light shaping” by GAVIN SINCLAIR et al. This document describes an iteration method for a hologram of a three-dimensional object. The object is sliced into a multitude of object layers. The encoded hologram with its complex actual values is transformed into each of the individual object layers one after another. In each of these planes, the complex actual values are compared with the complex set-point values, and the absolute portions of the actual values are replaced by the absolute portions of the set-point values. After back-transformation into the hologram plane, the individual values are added up for encoding. Due to the large number of object planes and the many transformations between the individual object planes and the hologram plane, this iteration method requires great computational power.

Although with the two-phase encoding method the SLM only modulates the phase of the light directly, the amplitude of the resulting complex wave field is also affected due to interference, according to the modulation by the SLM. For this an the above reasons, the amplitude must not be disregarded in iteration methods for the coding of the CGH as to be found in prior art.

The above-mentioned methods have the further drawback that a number of conditions must be fulfilled in order to be able to employ them in conjunction with holographic displays. This is not always possible in the required precision in practice. It is therefore very difficult to fully eliminate all and any influences mentioned which may lead to reconstruction errors. There will always remain a significant amount of error, so that high-quality reconstructions in holographic displays are not possible without applying a correction method. In addition, the known iterative correction methods related to three-dimensional objects require great computational power.

Now, the object of this invention is to improve the quality of encoding a CGH of a three-dimensional object on a light modulator based on phase encoding with the help of an iteration algorithm, so to enhance the reconstruction quality in a holographic display device and to achieve greater brightness and to improve the colour representation of the reconstruction.

This object is solved by a method in which the control values for the pixels of a light modulator for encoding a CGH are determined on the basis of given object data sets of a three-dimensional object. First, a two-dimensional distribution of a complex wave field is computed from the object data sets. According to the present invention, phase values are converted by transformation and phase encoding with k components into initial values for an iterative calculation of the control values for a phase-modulating SLM.

The control values of the code are calculated with the help of a computer in a holographic display device, this calculation comprising the steps of:
Forming from the distribution of N complex values of the wave field in the observer window a distribution of complex set-point values as a basis for comparison to be used in the iterative calculation of the codes, the observer window being situated within a defined transformation area;
Transformation of the distribution of complex set-point values into the light modulator plane and representation with the help of phase encoding, so to find for each complex value of the transform a number of k phase values as initial values for iterative calculation of the codes, where k is a numerical factor greater than 1; and
Calculation of repeating iteration steps between the observer plane, which contains the transformation area, and the light modulator plane, and interruption on occurrence of a defined interruption criterion, so to encode the CGH with the last calculated phase values.

The distribution of N complex set-point values in the observer window contains both the amplitude values and the phase values, because both values are required for error-free reconstruction of a three-dimensional object. When replacing the complex actual values by complex set-point values within the observer window, both the phase values and the amplitude values must always be replaced in each iteration step.

The defined and optically visible transformation area in the observer plane contains the observer window, which may be situated at any position inside the transformation area. For two-phase encoding, it is preferably situated in the centre of the transformation area and covers half of the transformation area. In a first step all object data sets are transformed into the observer window, where all N complex values are added up. As complex set-point values, they represent a scan of the distribution of set-point values of the entire optical information of the three-dimensional object in a single two-dimensional, complex-valued wave field and form the basis for the comparison of values in each step of the iteration process. In a further step, the set-point values are Fourier-transformed into the plane of the light modulator, whereby this information is provided in the form of complex values with a variable absolute portion for computing a phase code. The k·N phase values computed from the phase code are preferably converted into complex values with a constant absolute portion. They are used as initial values for iterative computation of the control values of the code and are back-transformed into the observer plane. There, they represent the complex actual values used for comparison and are compared with the complex set-point values in the observer window.

According to a further step of the invention, the initial values can be improved further by additional arithmetic operations. These arithmetic operations are performed after phase encoding but before iterative computation.

Adding up the complex values of the individual transforms in the observer window boasts the advantage that subsequent transformations for iterative calculation of the control values for encoding only have to be performed between two planes, namely the observer plane and the plane of the light modulator, which is the hologram plane at the same time. In contrast to prior-art solutions, it is not necessary to execute transformations between many object planes and the hologram plane. In contrast to known iteration methods, this process causes significantly lower computational load for holographic representation of three-dimensional objects.

According to the novel method, the following routine is executed in each iteration step:
Comparison of N complex actual values which are back-transformed from the plane of the light modulator with the N complex set-point values of the aggregated wave field within the observer window with respect to the defined interruption criterion
Replacing of the k·N complex actual values within the observer window, which are transformed into the transformation area, by the N complex set-point values and unchanged adoption of the (k−1)·N complex actual values in the transformation area, but outside the observer window, for iterative calculation
Execution of a new Fourier transformation of the k·N complex actual and set-point values in the plane of the light modulator and subsequent back-transformation into the transformation area, using only the k·N phase portions, while the absolute portions are set on a constant value.

According to another embodiment of the iterative calculation, the absolute value which corresponds to the characteristic of the light modulator at the respective calculated phase value can be used instead of the constant absolute values for the k·N phase values for back-transformation into the transformation area in each iteration step.

Both amplitude and phase values are of importance for reconstructing the wave field of the three-dimensional object. In each iteration step, both amplitude and phase of the complex actual values are thus replaced by the complex set-point values within the observer window. The calculated complex actual values in the transformation area outside the observer window are adopted for further transformations without any changes. Value comparison with a defined interruption criterion can be performed after each iteration step, or after a defined number of iteration steps.

An advantage of using the transformation area for calculating the transforms is that significantly less arithmetic operations, e.g. fewer Fourier transforms, must be executed, so that the iteration steps which are carried out until the defined interruption criterion is achieved are completed more quickly. In the holographic reconstruction of the three-dimensional object, the complex set-point values, which can be approximated quite well with the help of the novel method, represent the transformed object data and thus form a basis for comparison for the codes.

According to a further embodiment of this invention, the transformed N complex actual values within the observer window can in each iteration step also be replaced by the N complex set-point values such that a combination of set-point values and actual values, which is weighted by a constant c, is used. A new set-point value is then calculated according to the equation

new set-point value=c·set-point value+(1−c)·actual value, where 0<c≦2.

Factor c affects the iteration speed. If c=2, fewer iteration steps will generally suffice compared with the initially used iteration method (where c=1), so that the results are achieved more quickly. This case describes an over-compensation and means that actual values which are too large will be replaced by smaller values. Actual values which are too small will be replaced by larger values.

Such replacements are described by V. V. KOTLYAR in “An iterative weight-based method for calculating kinoforms”, where the author describes a so-called adaptive iterative method for a kinoform, which differs in that only the absolute portions of the complex values are replaced.

The method according to the present invention is used in a holographic display device which contains in addition to an optical system, which comprises at least one light source with sufficiently coherent light, a transformation lens and a light modulator for encoding a CGH, a processor to provide control signals and means for reconstructing a three-dimensional object and further means for executing the method. These means are in particular:
Selection means for the provision of object data sets of a three-dimensional object, for determining a transformation area for iterative calculation, and for adding the complex values of the transforms of the object data sets in the transformation area
Transformation means for the execution of the transformations between the object planes and the observer plane, and between the plane of the light modulator and the observer plane, and for the computation of the CGH codes
Comparing means for determining deviations between the complex set-point and actual values in the observer window and for signalling the interruption of the iteration when the defined interruption criterion is achieved, and
Reconstruction means for reconstructing the encoded CGH.

The light modulator is preferably a phase-modulating SLM, which coincides with the hologram plane of the CGH to be encoded. Encoded information about the three-dimensional object are holographically reconstructed by diffraction of sufficiently coherent light at the controllable pixels of the light modulator. The reconstruction may either be realised inside a space between observer plane and light modulator or behind the light modulator, seen from the observer plane. The reconstruction may even be visible partly in front of and partly behind the light modulator at the same time.

If a colour CGH is to be encoded, the iterative calculation is performed separately for the three primary colours.

The novel method makes it possible to easily realise a spatial separation of disturbing light (noise) and signal in a holographic display. The iterative calculation described above improves the quality of the control values for encoding the CGH and optimises the phase code used iteratively. A CGH which is computed and encoded according to this invention shows an improved hologram quality and thus a higher quality of the reconstruction of a three-dimensional object.

If the CGH is a colour hologram, it may be composed of sub-holograms which represent the individual primary colours (red, green, blue). In the light modulator, this may be realised by sub-pixels for each primary colour or by sequentially displaying sub-holograms each representing a primary colour. A sub-hologram is a monochrome CGH of the three-dimensional object. The iterative optimisation of the phase values, which are used as the control values for the pixels of the SLM, is in this case carried out separately for each primary colour. It is a prerequisite that each pixel of the SLM contains three sub-pixels for the three primary colours.

Now, the inventive method and a holographic display device for realising the method will be described below in detail in conjunction with the accompanying drawings, wherein

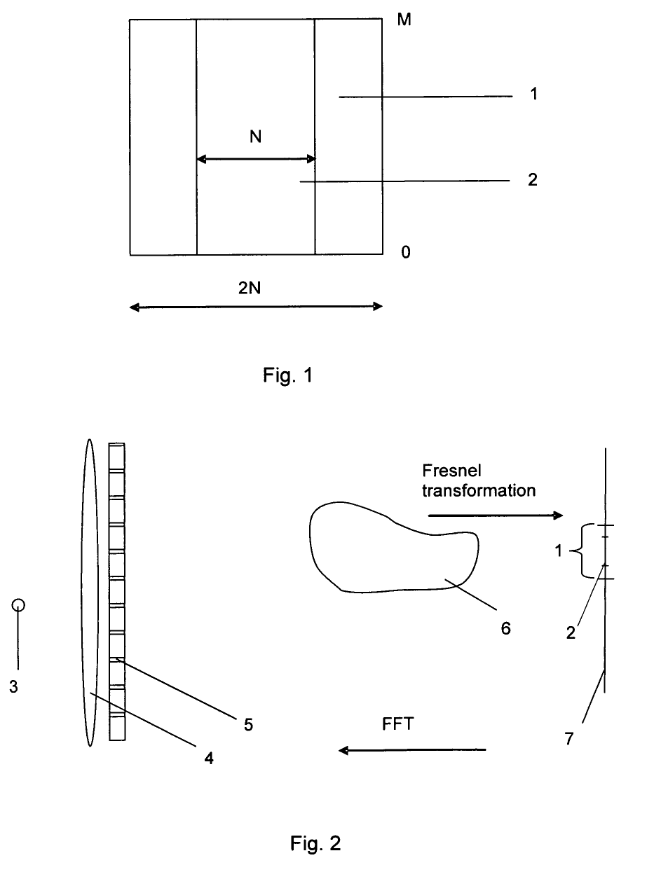

FIG. 1 shows in an observer plane a transformation area with an observer window arranged inside that area;

FIG. 2 is a schematic view of a reconstructed three-dimensional object in the space between light modulator and observer plane in a holographic display (top view);

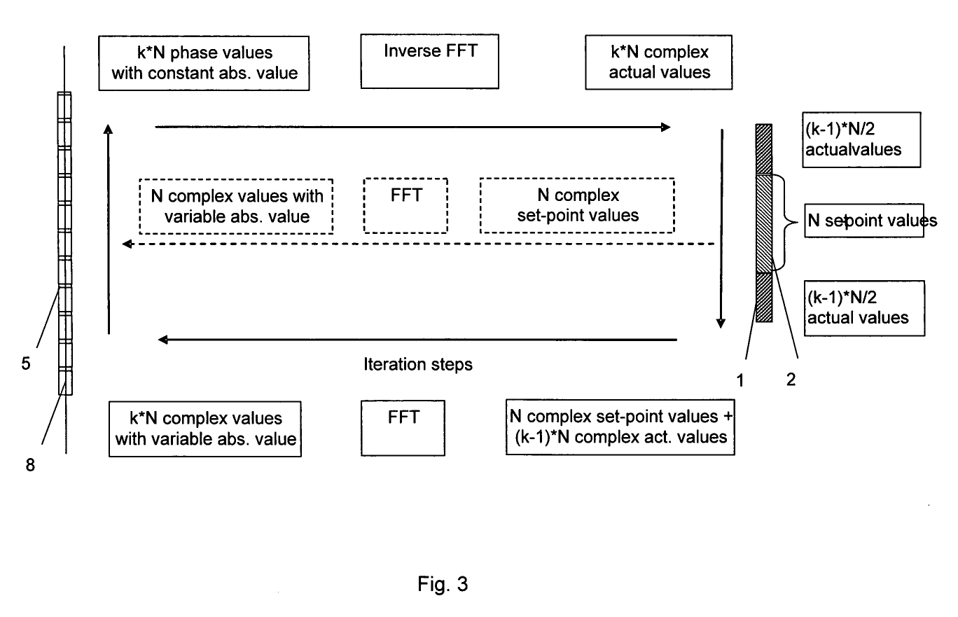

FIG. 3 is a schematic view of a Fourier transformation algorithm between observer and hologram plane, illustrating the repeated iteration steps;

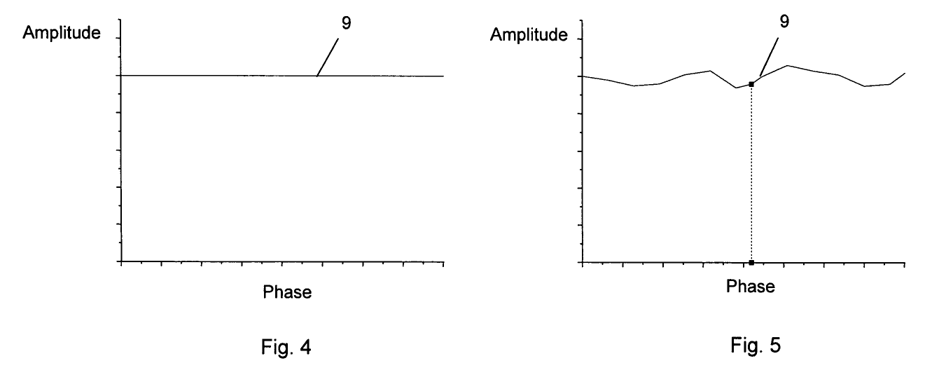

FIG. 4 shows the characteristic of an ideal phase-modulating SLM; and

FIG. 5 shows the characteristic of a real light modulator.

The inventive method is based on provided data sets of a three-dimensional object 6 sliced into a multitude of parallel, two-dimensional object layers (not shown), an observer window 2 in an observer plane 7 and a phase code for encoding a CGH in a light modulator 5, said phase code being optimised iteratively using a transformation algorithm. Further, technical means for executing this novel method in a holographic display device will be specified. Details of how the object 6 is sliced to get two-dimensional object layers and how object data sets and hologram data sets are generated to be used in the transformations are not included in the scope of this invention. They will only be described as far as necessary for understanding the iterative calculations.

Referring to FIG. 1, controllable selection means (not shown) define an optically visible transformation area 1 for executing the initially defined transformations. A special form of Fourier transformation used here is the fast Fourier transformation (FFT). A virtual observer window 2 is generated inside the transformation area 1. Using the observer window 2 known from document WO2004/044659 in conjunction with this method boasts the advantage that the region for transformation can be kept very small. The extent of the transformation area 1 is defined by the properties of the display used, namely its pixel size. In Fourier holograms the reconstruction continues periodically in an interval the extent of which is inversely proportional to the pitch of the pixels of the light modulator, where the pitch is the distance from the centre of one pixel to the centre of the adjacent pixel. The transformation area 1 is positioned in this interval. It has an extent of 2N. The two-dimensional transformations can be calculated in M rows in this transformation area. In two-phase encoding, the observer window 2 covers half of the transformation area 1.

Referring to FIG. 2, in a holographic display device a light source 3 which emits coherent light is disposed in front of a transformation lens 4 and a light modulator 5. These elements form the optical system of the holographic display device, which is required for illumination and for reconstruction with the help of Fourier transformations. The transformation area 1, in which the observer window 2 for observing the reconstruction of the three-dimensional object 6 is situated, lies in an observer plane 7. Arrows indicate the directions of the Fresnel transformations and the fast Fourier transformations (FFT).

FIG. 3 shows schematically the process of iterative calculation with the aim to improve the control values for encoding a CGH on the light modulator 5. A Fourier transformation algorithm with individual iteration steps is executed between the light modulator 5 with the hologram plane 8 and the transformation area 1 with the observer window 2. In a first step, represented by a dashed line in the Figure, the distribution of complex set-point values in the observer window 2 is determined.

FIG. 4 shows the ideal characteristic of a phase-modulating SLM, and FIG. 5 shows its real characteristic. Characteristic 9 expresses the relationship between the phase and amplitude of the transmission or reflection of the phase-modulating SLM. If used in the display device the said SLM effects no ideal phase modulation—also the amplitudes and thus the absolute portions of the complex-valued wave fields of the light are affected. In order to take this effect into account, the iterative calculation is executed after phase encoding using absolute values according to the ideal characteristic 9 of the light modulator 5 which correspond to the calculated phase value. According to another embodiment of the invention, the iterative calculation after the phase encoding is performed using constant absolute values.

The description of phase encoding below relates mainly to two-phase encoding of a CGH.

A phase-modulating SLM which only allows phase values to be represented is used as light modulator. Fourier-transformed complex values calculated from the object data sets are transformed into phase values by way of phase encoding. The amplitudes of the complex values are first normalised to fit in a range between 0 and 1. Each complex number with the phase ψ and the amplitude a ranging between 0 and 1 can be represented by the sum of two complex numbers with the absolute value 1 and the phase values ψ±a cos a. This means in particular in the context of phase encoding that a complex number can be represented by two phase values with constant amplitude.

If it was possible to encode the two phase values at one and the same position on the phase-modulating SLM, a thus encoded CGH made it achievable to reconstruct the three-dimensional object 6 free of errors. In practice, however, the two phase values can only be written to two adjoining controllable pixels, which are combined to form one element of the phase-modulating SLM, so that they are offset locally. That offset causes errors in the reconstruction of the CGH. The inventive encoding method serves as a solution for reducing or correcting that error. Thanks to the novel method the control values for CGH encoding are improved such that the wave field to be reconstructed is approximated to the ideal wave field of the object 6 with as little error as possible.

In order to be able to apply the iterative calculation to more than two phase values, a numerical factor k>1 is introduced as a factor describing the ratio of phase values to complex numbers represented by the phase values. For the two-phase encoding k equals 2. In general k may also be a non-integer value. E.g. if k=2.5, then it means that 2 complex values are represented by 5 phase values. With a greater number of k phase values, e.g. 4 for one complex value, the phase values can also be coded two-dimensional in one pixel of two adjacent columns and rows.

The numerical factor k also influences the dimension of the observer window 2. The greater k the smaller is the observer window 2. Thus the area of the observer window will be the 1/k th part of a diffraction order.

The initial point of the method is the above-mentioned three-dimensional object 6, which is sliced into a multitude of two-dimensional parallel object layers. Any number of object layers can be used. The more object layers the more precise is the reconstruction. The sliced object 6 is provided by a selection means in row-wise object data sets with N complex values. There are as many object data sets as there are object layers. The N complex values of the corresponding rows of the object data sets are Fresnel-transformed into the observer window 2 of the previously defined transformation area 1 in the observer plane 7 and added up there. This means that in the observer plane 7 the wave field is calculated for each object layer and the values of all the individual wave fields are added up to form an aggregated wave field which contains the information of all transformed object layers of the object 6. By this adding operation, a distribution of N complex set-point values per row is provided by way of calculation, which forms the basis for comparison for the iterative calculation of the CGH.

The iterative calculation can be applied to both CGHs with full parallax and to CGHs with horizontal-only or vertical-only parallax. In the first case, which represents the most general case, there are M rows and N columns for the transformations in the object layers, i.e. M·N complex values for calculating the two-dimensional Fourier transforms. After two-phase encoding, there are M rows with 2·N phase values each in the phase-modulating SLM, i.e. 2·M·N values. However, the entire CGH with all its rows can be optimised iteratively at the same time. The complex values of all M rows and for the columns the N complex values (see FIG. 1) are used for the transformations in the observer window 2.

In the case of a horizontal-only parallax the process is carried out row-wise, i.e. the complex values to be transformed and back-transformed in the transformation means (actual values, set-point values and phase values) are generally related to a particular row. In the case of a vertical-only parallax the pixels above one another in one column must be encoded, i.e. 2·M complex values must be optimised column-wise using the iterative calculation method. The observer window 2 then has a vertical extent that is half as large as that of the transformation area 1.

The transformation area 1 is located within one periodicity interval. This means that the transformation area 1 continues periodically in the reconstruction of the CGH.

Referring to the schematic view in FIG. 3, the process of the iterative calculation will now be described. The N complex set-point values in the observer window 2, which are contained in M rows, undergo a fast Fourier transformation (FFT), so that they are transformed into the plane of the light modulator 5. These transformed complex values are used to calculate a two-phase code and to encode the CGH of the object 6 on the phase-modulating SLM. Because each complex value is represented by two phase values, as described above, the encoding results in 2·N phase values with a constant absolute value e.g. the absolute value 1. 2·N complex values with an absolute value of 1 are thus provided as initial values for the iteration.

The iterative calculation begins with the thus determined initial values. First, the 2·N complex values are back-transformed into the transformation area 1. The back-transformation results in actual values for the wave field of the object 6 to be reconstructed. Within the observer window 2 of the transformation area 1 the N complex actual values are compared with the N complex set-point values. After this comparison, the N complex actual values which are transformed into the observer window 2 in the transformation area 1 are replaced by the N complex set-point values. The N complex actual values the observer window 2 are used without any changes in the next transformation. The complex actual and set-point values are transformed into the plane of the light modulator 5. This transformation results in 2·N complex values with variable absolute portion. In the subsequent back-transformation (FFT) into the transformation area 1, only the 2·N phase values are used, the amplitude values are set to a constant value. The next iteration step starts now with new values. The process described is repeated until a defined interruption criterion is reached. Each iteration step minimises the deviation between the complex actual values and the complex set-point values in the observer window 2, and the deviation between the complex values and the constant value in the plane of the light modulator. The control values for encoding the CGH are thus improved continuously. They are converted into control signals in a processor and encode the CGH according to the last calculated phase values, which correspond to hologram data sets.

With the hologram data sets encoded on the phase-modulating SLM a precise holographic reconstruction of the three-dimensional object 6 can be generated with reconstruction means, which contain an accordingly controlled illumination wave. An observer, with his eye positions being detected with the help of known position detection systems, can see the holographic reconstruction of the three-dimensional object 6 through the observer window 2 (see FIG. 2).

The interruption criterion is defined in a comparing means such that an approximation reaches a defined accuracy of the distribution of set-point values while keeping the computational load in a reasonable range. Various parameters may serve as interruption criteria:
The sum of the square deviations of the actual values from the set-point values at all scan points within the observer window 2; or
The signal-to-noise-ratio resulting from a), which equals the sum of the squares of the set-point values/sum of the squares of the deviations; or
The maximum deviation at a scan point within the observer window 2; or
A weighted combination of mean and maximum deviation of the actual values from the set-point values.

At the beginning of the iterative calculation, or before the first transformation, varying the distance of each object data set to the observer plane 7 preferably results in the entire reconstruction of the three-dimensional object 6 or parts thereof being visible both in front of and behind hologram plane 8. This way both a natural depth position of the reconstruction in the space in front of the observer's eyes and a deliberate amplification or reduction of the depth effect of the CGH can be realised through software settings.

The reconstruction of the three-dimensional object 6 in an observer window 2 was described for one eye only. In order to be able to perceive the holographic reconstruction in a true three-dimensional manner, as if the object was viewed in reality, reconstructions of two CGHs in two separate virtual observer windows 2 are required, namely one for each observer eye. Both reconstructions are computed using the same method, but different object data sets (because of the different positions of the left and right observer eyes relative to the three-dimensional object 6). The CGHs can be computed at the same time and absolutely independently of each other in accordingly equipped multi-channel digital processors with simultaneously executed transformation routines.

Generally, the method described above can also be applied to a holographic display device where a transformation area 1 contains two observer windows 2 with a dimension that covers both eyes of an observer. This allows to simultaneously present both eyes error-free holographic reconstructions.

According to a further embodiment of the iterative calculation method, the N transformed complex actual values can be replaced by a weighted combination of the N complex set-point values and actual values with a constant c within the observer window 2 as follows:

new set-point value=c·set-point value+(1−c)·actual value, where 0<c≦2.

The case c=1 corresponds with the iteration process described above. The case c=2 describes an overcompensation. On scan points in the plane of the light modulator 5 where the last iteration step yielded actual values which are greater than the set-point values, these values are replaced by smaller ones and vice versa. The constant c affects the number of iteration steps required until the interruption criterion is achieved. Usually, fewer iteration steps are required if c=2, the remaining error is minimised more quickly.

According to yet another embodiment of the invention, the initial values for iterative calculation can be improved further by implementing additional arithmetic operations. This boasts the advantage that in the subsequent iterative calculation the interruption criterion will be reached more quickly. This means that values derived from the two-phase encoding are used as initial values.

The control signals detected by the processor are provided to the selection means, transformation means, comparing means and control means for use in the holographic display device. The transformations and the CGH encoding are carried out by dedicated transformation means, e.g. the transformations are carried out in the optical system, namely by the transformation lens 4.

The novel iterative calculation method integrated into a holographic display device boasts the advantage that the error term of the Fourier transforms can be reduced uniformly in conjunction with phase encoding. Thus, in the region in front of the display where the observer eyes are located the reconstruction is represented without errors.

Another advantage results from the fact that by defining the size of a transformation area 1 to stretch beyond the observer window 2, degrees of freedom are gained to improve the quality of the control values for encoding in the transformation area 1. A part of the wave field in the observer plane 7, namely the part outside the observer window 2, can thus be chosen freely, while the other part, within the observer window 2, is fixed.

In contrast to prior-art solutions, purposeful replacement of the found actual values by the set-point values defined by the object 6 within the observer window 2 leads to a high-quality reconstruction through the individual iteration steps, without having to consider each individual object layer.

The transformations in each iteration step only take place between the observer plane and the hologram plane.

Another advantage is that controllable values for the pixels of the elements of the light modulator 5 are gained from the original complex values of the CGH.

### REFERENCE NUMERALS

1—transformation area
2—observer window
3—light source
4—transformation lens
5—light modulator
6—object
7—observer plane
8—hologram plane
9—characteristic of the light modulator 5
k—numerical factor for phase values
FT—Fourier transformation
FFT—fast Fourier transformation

1. A method for encoding a computer-generated hologram (CGH) of a three-dimensional object on a light modulator of a holographic display comprising:
configuring the light modulator to comprise electronically controllable pixels, which are arranged in a regular pattern;
providing the light modulation with control signals for CGH encoding by a processor; and
calculating a two-dimensional distribution of N complex values of a wave field by transforming given object data sets of a three-dimensional object into a virtual observer window in an observer plane, wherein:
The two-dimensional distribution of N complex values of the wave field in the observer window forms a distribution of complex set-point values as a basis for comparison to be used in the iterative calculation of the control values for the code, the observer window being situated within a defined transformation area;
The distribution of complex set-point values is transformed into a plane of the light modulator and represented with the help of phase encoding, so as to find for each complex value of the transforms k phase values as initial values for iterative calculation of the control values for the codes, where k is a numerical factor greater than 1; and
The iterative calculation is executed in repeating iteration steps between the observer plane, which contains the transformation area, and the plane of the light modulator, and interrupted on occurrence of a defined interruption criterion, so to encode the CGH with the last calculated phase values as control values.

2. Method according to claim 1 where for calculating the distribution of complex set-point values, all complex values of the object data sets to be transformed are added up in the observer window so to form a distribution of N complex set-point values and then transformed with the help of a Fourier transformation (FT) into the plane of the light modulator as complex values with variable absolute value.

3. Method according to claim 1 where the code for phase encoding is calculated based on the transformed complex values in the plane of the light modulator, and where the k·N phase values resulting from the calculation of the code for phase encoding are back-transformed into the observer plane with an absolute value according to the characteristic of the light modulator at the corresponding calculated phase value.

4. Method according to claim 1 where each repeating iteration step comprises the following routine:
Comparison of N complex actual values which are back-transformed from the plane of the light modulator with the N complex set-point values of the aggregated wave field within the observer window with respect to the defined interruption criterion;
Replacing of the k·N complex actual values within the observer window, which are transformed into the transformation area, by the N complex set-point values and unchanged adoption of the (k−1)·N complex actual values in the transformation area, but outside the observer window, for iterative calculation;
Execution of a new Fourier transformation of the k·N complex actual and set-point values in the plane of the light modulator and subsequent back-transformation into the transformation area, using only the k·N phase portions, while the absolute portions are set on a constant value.

5. Method according to claim 4 where the absolute values of the k·N phase values are the values which correspond to the characteristic of the light modulator at the respective calculated phase values.

6. Method according to claim 1 where the phase encoding is a two-phase encoding.

7. Method according to claim 4 where in each repeating iteration step the complex actual values are replaced by the complex set-point values within the observer window.

8. Method according to claim 4 where within the observer window the value comparison with respect to a defined interruption criterion is performed after each repeating iteration step, or after a defined number of iteration steps.

9. Method according to claim 1 where the three-dimensional object is holographically reconstructed in a space between the observer window and light modulator and/or behind the light modulator.

10. Method according to claim 1 where the phase values are encoded row-wise on the light modulator if a CGH with horizontal-only parallax is used.

11. Method according to claim 1 where the phase values are encoded column-wise on the light modulator if a CGH with vertical-only parallax is used.

12. Method according to claim 1 where each repeating iteration step comprises the following routine:
Comparison of N complex actual values which are back-transformed from the plane of the light modulator with the N complex set-point values of the aggregated wave field within the observer window with respect to the defined interruption criterion;
Replacing of the N complex actual values within the observer window, which are transformed into the transformation area, by a combination of set-point values and actual values which is weighted by a constant c, according to the equation
new set-point value=c·set-point value+(1−c)·actual value, where 0<c≦2
and unchanged adoption of the calculated N complex actual values in the transformation area but outside the observer window; and
Execution of a new Fourier transformation of the k·N complex actual and set-point values in the transformation area into the plane of the light modulator and subsequent back-transformation into the observer plane, either using only the k·N phase portions while the absolute portions are set on a constant value, or using only the k·N phase portions, while the absolute portions are set on a value which corresponds to the characteristic of the phase modulator at the respective calculated phase value.

13. Holographic display device for realising the method according to claim 1 with an optical system which comprises at least one light source with coherent light, a transformation lens and a light modulator for encoding a CGH, with a processor to provide control signals for CGH encoding and means for reconstructing a three-dimensional object, said reconstruction being visible through a virtual observer window in an observer plane, where the control signals for encoding are found with the help of iterative calculation, comprising:
Selection means for the provision of object data sets of a three-dimensional object, for determining a transformation area for iterative calculation, and for adding the complex values of the transforms of the object data sets in the transformation area;
Transformation means for the execution of the transformations between object planes and the observer plane, and between the plane of the light modulator and the observer plane, and for the computation of the CGH codes;
Comparing means for determining deviations between the complex set-point and actual values in the observer window and for signalling the interruption of the iteration when the defined interruption criterion is achieved; and
Reconstruction means for holographically reconstructing the encoded CGH.

14. Holographic display device according to claim 13 where the light modulator is a phase-modulating SLM and contains the encoded CGH.

15. Holographic display device according to claim 13 where the reconstruction of the three-dimensional object is realised by way of diffraction of sufficiently coherent light emitted by the light source on the controllable pixels of the light modulator.

16. Holographic display device according to claim 13 where an iterative calculation of the phase values is executed separately for each primary colour when encoding a colour CGH.

17. Holographic display device for realising the method according to claim 12 with an optical system which comprises at least one light source with coherent light, a transformation lens and a light modulator for encoding a CGH, with a processor to provide control signals for CGH encoding and means for reconstructing a three-dimensional object, said reconstruction being visible through a virtual observer window in an observer plane, where the control signals for encoding are found with the help of iterative calculation, comprising:
Selection means for the provision of object data sets of a three-dimensional object, for determining a transformation area for iterative calculation, and for adding the complex values of the transforms of the object data sets in the transformation area;
Transformation means for the execution of the transformations between object planes and the observer plane, and between the plane of the light modulator and the observer plane, and for the computation of the CGH codes;
Comparing means for determining deviations between the complex set-point and actual values in the observer window and for signalling the interruption of the iteration when the defined interruption criterion is achieved; and
Reconstruction means for holographically reconstructing the encoded CGH.

18. Holographic display device for use with an optical system having at least one light source with coherent light, a transformation lens and a light modulator for encoding a CGH, with a processor to provide control signals for CGH encoding, and means for reconstructing a three-dimensional object, said reconstruction being visible through a virtual observer window in an observer plane, where the control signals for encoding are found with the help of iterative calculation, comprising:
selection means for the provision of object data sets of a three-dimensional object, for determining a transformation area for iterative calculation, and for adding the complex values of the transforms of the object data sets in the transformation area;
transformation means for the execution of the transformations between object planes and the observer plane, and between the plane of the light modulator and the observer plane, and for the computation of the CGH codes;
comparing means for determining deviations between the complex set-point and actual values in the observer window and for signalling the interruption of the iteration when the defined interruption criterion is achieved; and
reconstruction means for holographically reconstructing the encoded CGH.
